(19) United States
(12) Patent Application Publication
(10) Pub. No.: US 2025/0229750 A1
(43) Pub. Date: Jul. 17, 2025

(54) Transmission Brake Release Trigger and Method of Operation

(71) Applicant: Jerry Stiller, Wylie, TX (US)

(72) Inventor: Jerry Stiller, Wylie, TX (US)

(21) Appl. No.: 19/017,180

(22) Filed: Jan. 10, 2025

Related U.S. Application Data
(60) Provisional application No. 63/620,120, filed on Jan. 11, 2024.

(51) Int. Cl. B60T 7/08

(52) U.S. Cl. CPC B60T 7/085; B60Y 2200/114

(57) ABSTRACT

A transmission brake release trigger and method of operation, designed to enhance consistency and reduce reaction time for bracket drag racing and other competitive motorsports. The system includes a precisely engineered trigger mechanism, incorporating a sear lever, trigger lever, and industrial micro switch assembly. This innovative design achieves an average reduction in leave time of 0.020 seconds and offers improved reaction consistency across various racing scenarios. The invention supports both normally closed (NC) and normally open (NO) switch configurations, enabling adaptability for different racing styles and event requirements. Key features include spring-loaded components for reliable engagement, ergonomic trigger action for user convenience, and quick reset capabilities. Multiple embodiments are described, including direct contact switch designs for instant-on green racing. The modular construction ensures compatibility with various vehicle configurations. This inventive trigger mechanism offers superior performance for racers seeking faster and more consistent starts.

### FEDERALLY SPONSORED RESEARCH

Not Applicable

### SEQUENCE LISTING OR PROGRAM

Not Applicable

### TECHNICAL FIELD OF THE INVENTION

The present invention relates to a transmission brake release or disengagement switch or trigger for mounting on a drag race vehicle. More specifically, the present invention relates to a manual transmission brake release or disengagement switch or trigger device for mounting on a drag race vehicle providing a mechanical means for sending an electrical signal to affect the disengagement of an electrically activated transmission brake of a drag race vehicle.

### BACKGROUND OF THE INVENTION

At the flash of the yellow, most drag racers will lift their thumb off of a transbrake button by pulling their arm straight back or up. In that particular motion, the racer will use somewhere between 20 to 25 muscles to release the transbrake. There are a lot of variables when using this technique. Fatigue, the position of a 5-layer driving suit, the position of the thumb on the button, pressure applied to the button, along with the inadequacies of the commonly used button's internals. All of this adds up to inconsistency.

The present invention uses a fraction of those muscles and joints. But more importantly, it eliminates many of those other variables. In comparison in high end target shooting, shooters know how crisp and consistent those riffle triggers are and strive to eliminate all variables that may lead to inconsistencies in their shooting as a result of the trigger pull and hand/finger action. The present invention has the exact same effect as a high-end custom rifle trigger, but for a drag racer leaving off a transbrake.

Through extensive research and development and testing, both in car and on a practice tree, the present invention has been shown to be quicker and more consistent than standard buttons currently known and widely used. The present invention also works very well with top bulb racers. The added consistency is a must at big money bracket races which often have racers with packages as tight or tighter than electronic classes.

The internal workings of the trigger taught by the present invention all but eliminate the inconsistencies of the switch itself, which is a huge advantage over current offerings in the market. Most buttons use a light spring to push back the button top and release the contacts. Friction differences from surface contaminants and button cap cocking are eliminated by the present invention.

The present invention teaches and uses internal springs that are much stronger than a button switch plunger to actuate the industrial controls switch in the heart of device taught by the present invention. The switch device taught by the present invention does not rely on internals in the switch to actuate. Levers inside of the switch device taught by the present invention are precision machined like a custom rifle trigger to consistently break and operate the switch.

### SUMMARY OF THE INVENTION

The present invention teaches a transmission brake release trigger and a method of operation that surpasses existing devices in terms of efficiency and consistency. Engineered specifically to minimize reaction time, this innovation demonstrates superior performance compared to traditional transbrake switches. One remarkable aspect is its remarkable consistency, outperforming all tested and known transbrake switches in the prior art. The invention boasts an average reduction in leave time of 0.020 seconds, providing a significant advantage, especially on a fast-paced 0.400 pro tree or instant-on green.

The detailed illustrations in the figures depict the structure and components of the transmission brake release trigger. The main housing retains an industrial micro switch with two electrical connectors, essential for connection to a standard electrically operated transmission brake. A sear lever, mounted above the micro switch, is pivotal in the mechanism. A single lever pivot connects one end of the sear lever within the main housing, engaging a sear spring 4 in a pocket machined into the housing. The opposing end of the sear lever extends externally, facilitating re-setting, loading, or cocking of the sear lever and connected trigger.

The trigger lever, positioned perpendicular to the sear lever, is held in place by a pivot point on the main housing. Trigger springs, located in internal recesses, create pressure on the trigger lever, requiring force to move it. The trigger engages a recess on the sear lever, and its external end extends for an external trigger pull.

In operation, the external sear lever end is moved upward, engaging the sear lever and trigger lever. The trigger and sear lever are loaded or cocked, ready for release. Pulling the external trigger lever initiates a forward motion, aligning the trigger lever with the sear lever's recess. The engaged pin plunger activates the internal industrial micro switch, sending a signal to the electronic transmission brake.

To reset the assembly, the external sear lever end is raised, moving the trigger lever internally. The sear lever recess disengages from the internal trigger end, held in place by sear springs 4. The sear lever rests against the internal trigger lever end until the next operation.

The interaction between the sear lever and trigger lever, along with the forces applied by respective springs, enables the trigger to remain loaded until pressure is applied, allowing the trigger lever to move forward. This aligns the trigger lever end with the sear lever recess, enabling the sear lever to drop and engage the trigger lever end, activating the micro switch.

The method of operation begins when a racer positions their vehicle at the staging beams. Instead of pushing the traditional transbrake switch, the racer pushes up on the external sear lever end to set the transbrake switch and trigger. Releasing the transbrake switch involves pulling the external trigger, allowing the external sear lever end to move down and push in on the micro switch's plunger. The micro switch is electrically connected from the common to the normally closed (NC) position in this mode.

An alternative embodiment allows installation with the pin in the opposite direction for normally open (NO) operation, albeit with slower actuation of the transmission brake switch device.

In yet another alternative embodiment, the electrical contact is from the top connection to the flat contractor strap held in place by the screw. When the sear lever is set the trigger lever moves forward, flexing the contactor trigger spring through the transfer ball onto the lower electrical connection. The transfer ball is nonconductive, is loose in the bore and applies force to the flat spring contactor to make the connection.

### REFERENCE CHARACTERS AND PARTS LIST

1. Main Housing
2. Main Housing Mate
3. Industrial Micro Switch
4. Sear Spring
5. Housing Cover
6. Electrical Connections
7. Sear Lever
8. Pivots for Levers
9. Pin Plunger That Activates Internal Industrial Micro Switch
10. Trigger Springs
11. Trigger Lever
12. Switch Block
13. Primary Switch Contact
14. Secondary Switch Contact
15. Transfer Ball
16. Flat Spring Contactor

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a top, rear perspective view of the assembled release trigger taught by the present invention.

FIG. 2 illustrates a top, front perspective view of the assembled release trigger taught by the present invention.

FIG. 3 illustrates a bottom, rear perspective view of the assembled release trigger taught by the present invention.

FIG. 4 illustrates a bottom, front perspective view of the assembled release trigger with the main housing mate removed as taught by the present invention.

FIG. 5a illustrates a planar view of the assembled release trigger taught by the present invention with the main housing mate omitted showing all the internal components and their orientation and reference positions with respect to all other components.

FIG. 5b illustrates and expanded/exploded view of the components of the present invention.

FIG. 6a is a perspective view of the main housing of the present invention which illustrates the various recess and internal cavities necessary for the illustrated embodiment of the present invention.

FIG. 6b is an external side planar engineering view of the main housing of the present invention.

FIG. 7a is a perspective view of the main housing mate of the present invention.

FIG. 7b is an external side planar engineering view of the main housing of the present invention.

FIG. 7c is an external side planar view of the main housing of the present invention.

FIG. 8 is a perspective view of the trigger of the present invention.

FIG. 9 is a perspective view of the sear lever of the present invention.

FIG. 10 illustrates a planar view of the assembled release trigger taught by the present invention with the main housing mate omitted showing all the internal components and their orientation and reference positions with respect to all other components for a direct contact embodiment using a switch block.

FIG. 11 illustrates a planar view of the assembled release trigger taught by the present invention with the main housing mate omitted showing all the internal components and their orientation and reference positions with respect to all other components for a second direct contact embodiment using a switch block.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention is a transmission brake release trigger and method of operation that is superior to current transmission brake devices and methods of operation. The present invention was specifically engineered to reduce reaction time. An added benefit of the design of the present invention is that it is also much more consistent than any other transbrake switches tested and known in the prior art. The average reduction in leave time of the present invention is 0.020 or 2 hundredths of a second. This is a tremendous advantage on a 0.400 pro tree or instant on green. In testing, unexpected results have shown a tighter reaction window when using the trigger taught by the present invention.

The overall design and philosophy of the present invention is that it was initially designed for the bracket drag racer. The present invention was designed for a more consistent reaction versus a faster reaction. During research and development of the present invention it was through this extensive research and development that in additional to being more consistent in reaction time, the reactive time was as found to be quicker as to achieve the total driver and car reaction time of previous devices and as the standard for testing and evaluation, to obtain the same combined driver and car reactive time, more delay is required to be put into a delay box to make up for the faster driver reaction time.

Now that heads up racing is so popular, the quicker reaction is an unexpected result and a good selling point as the device of the present invention, which unexpectedly resulted in not only more consistent reaction times, but a quicker reaction time makes it adaptable and more desirable to cars in classes with varying rules and starting line and starting/Christmas tree settings.

Now referring to the figures the transmission brake release trigger and method of operation taught by the present invention is illustrated.

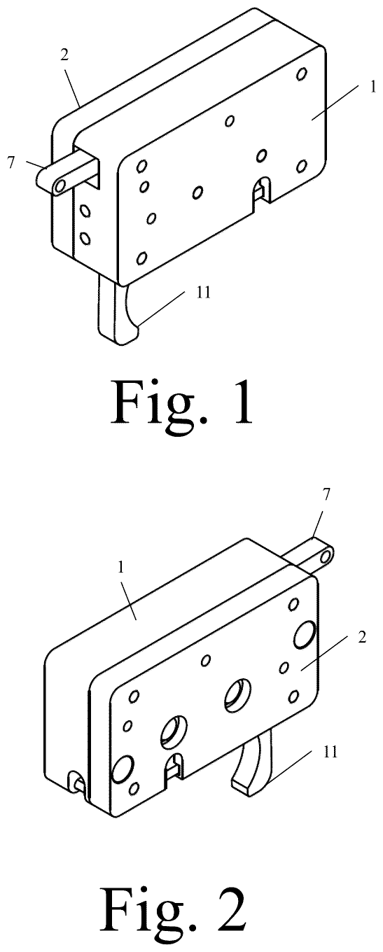

FIG. 1 illustrates a top, rear perspective view of the assembled release trigger taught by the present invention. In this figure the perspective view of the main housing 1 side is illustrated. The trigger extends from the bottom external surface of the assembled device and the sear level extends from the rear external surface of the assembled device. The front external surface and top external surface of the assembled device have no protrusions.

FIG. 2 illustrates a top, front perspective view of the assembled release trigger taught by the present invention. In this figure the perspective view of the main housing mate 2 side is illustrated. The trigger extends from the bottom external surface of the assembled device and the sear level extends from the rear external surface of the assembled device. The front external surface and top external surface of the assembled device have no protrusions.

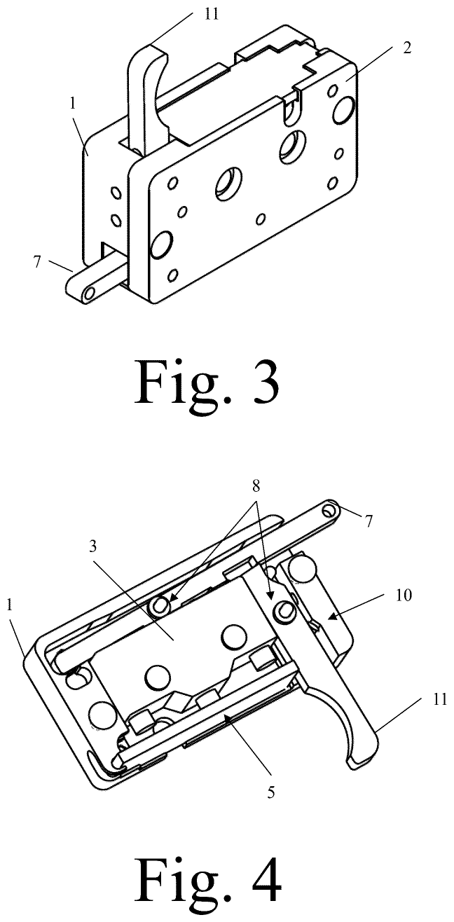

FIG. 3 illustrates a bottom, rear perspective view of the assembled release trigger taught by the present invention. In this figure the perspective view of the main housing 1 side is illustrated. The trigger extends from the bottom external surface of the assembled device and the sear level extends from the rear external surface of the assembled device. The front external surface and top external surface of the assembled device have no protrusions.

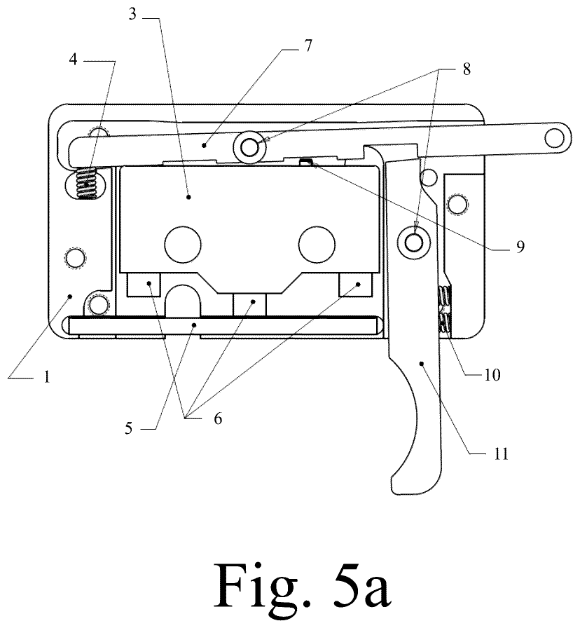

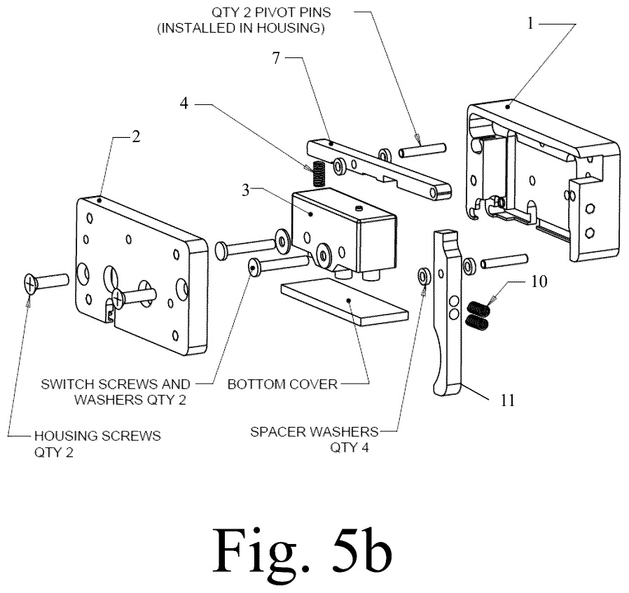

FIG. 4 illustrates a bottom, front perspective view of the assembled release trigger with the main housing mate 2 removed as taught by the present invention. FIG. 5a illustrates a planar view of the assembled release trigger taught by the present invention with the main housing mate 2 omitted showing all the internal components and their orientation and reference positions with respect to all other components. FIG. 5b illustrates and expanded/exploded view of the components of the present invention.

As illustrated in FIGS. 4 and 5a-5b, the components of the present invention include a main housing 1 for retaining an industrial micro switch 3 with two electrical connections 6 for connection to a standard electrically operated transmission brake. A sear lever 7 is mounted above the industrial micro switch 3. The sear lever 7 is mounted to the main housing 1 using a single lever pivot 8. A first sear lever 7 end is retained within the main housing 1 and engages a sear spring 4 retained in a sear spring 4 pocket or recess machined into the main housing 1. An opposing end of the sear lever 7 spring end extends from an opening in the main body housing providing an external means for re-setting, loading, or cocking the sear lever 7 and connected trigger. The trigger lever 11 is mounted perpendicular to the sear lever 7 engaging and being retained in position by a pivot 8 point on the main housing 1. One or more trigger springs 10 are located in an internal recesses or pocket on the main housing 1. The trigger springs 10 create pressure on the trigger lever 11 which must be overcome in order for the trigger lever 11 to be moved. One end of the trigger engages a recess on the sear lever 7 while an opposing end of the trigger lever 11 extends from an opening in the main housing 1, creating an external trigger pull.

As illustrated in FIG. 5b, pivot 8 pins engage the main housing 1 and the respective sear bar and trigger with a pluarality of spacers/washers on each pivot 8 pin providing spacing between the sear bar and trigger and main housing 1 and main housing mate 2 for securing the sear bar and trigger there between and allowing the sear bar and trigger to rotate without binding and sear spring 4s and trigger springs 10 provide pressure force against their respective sear bar and trigger to keep them in proper position and orientation. A pair of switch screws secure the micro switch 3 to the min housing and a pair of housing screws secure the main housing 1 and main housing mate 2 together with a bottom housing cover 5, to retain and seal all internal components in place.

In operation, the external sear lever 7 end or portion extending from the main housing 1 is moved in a direction upward from the main housing 1. This upward moving action creates an engagement the sear lever 7 and the internal end of the trigger lever 11 where the springs of trigger lever 11 created a rear or backward pressure on the internal end of the trigger lever 11 which places the end of the trigger lever 11 is placed in a position just adjacent to the recess on the sear lever 7. The sear lever 7 springs create an upward pressure on the internal end of the sear lever 7, which creates a downward pressure on the sear lever 7 end against the trigger leaver. In this position the trigger and sear lever 7 are loaded or cocked and ready for release.

When the external trigger lever 11 end extending from the main housing 1 is pulled in a reward direction by a user, the trigger lever 11 pivot 8 creates a forward motion for the internal opposing end of the trigger lever 11. When the internal end of the trigger leaver moves forward, the internal end of the trigger lever 11 aligns with the recess on the sear lever 7 and the sear lever 7 is then able to move in a downward direction toward the trigger lever 11. When the sear lever 7 recess moves over the end of the trigger lever 11, a pin plunger 9 which activates the internal industrial micro switch 3 is engaged by the sear lever 7 and the switch is engaged, sending a signal to the electronic transmission brake.

To reset, reload, or cock the assembly, the external sear level end is raised back upward until the trigger lever 11 and its associated trigger springs 10 move the trigger lever 11 internal end reward and the external trigger end forward in the same fashion as a rifle or weapon trigger and the sear lever 7 recess is disengaged from the internal trigger end and the sear lever 7 rests against the internal trigger lever 11 end and is held in place by the pressure created by the sear springs 4 on the opposing end of the external sear spring 4 via the sear lever 7 pivot 8.

In operation, the sear lever 7 has a sear spring 4 located near the internal sear spring 4 end which creates an upward force on the internal sear spring 4 end, which transfers via the sear lever 7 pivot 8 to the external sear lever 7 end as a downward force. It is this sear spring lever that creates the pressure to keep the sear lever 7 engaged against the trigger lever 11 and that causes the sear spring 4 recess to move or engage over the trigger lever 11 when the trigger is pulled.

The trigger springs 10 create a forward pressure on the external trigger lever 11 end which is transfers via the trigger lever 11 pivot 8 to the internal trigger lever 11 end creating a reward pressure on the trigger lever 11 which is used to keep the trigger engaged against the external sear lever 7 end in a loaded or cocked position until the trigger spring pressure is overcome, typically by the squeezing pressure of a user.

Due to the relationship between the sear lever 7 and trigger lever 11 and the forces applied by the sear lever 7 springs and trigger lever 11 springs, the trigger lever 11 can be retained in a loaded or cocked position until the trigger lever 11 spring pressure is overcome allowing the internal end of trigger lever 11 to move in a forward or inward direction bringing the trigger lever 11 end in alignment with the sear lever 7 recess, allowing the sear lever 7 to drop down as a result of the sear lever 7 spring pressure and engage the trigger lever 11 end, while the sear lever 7 also engages a pin plunger 9 on the industrial micro switch 3 that activates the switch sending a signal to the electronic transmission brake. This relationship also allows for the external sear lever 7 end to be placed by into a loaded or cocked position by simply applying pressure and moving the external sear lever 7 end in an upward direction until the sear lever 7 springs are compressed and the recess of the sear lever 7 is above the internal end of the trigger lever 11 and the trigger lever 11 springs move the internal trigger lever 11 end in a backward direction disengaging the internal trigger lever 11 end from the sear lever 7 recess where the sear lever 7 rests on top of the internal trigger lever 11 end in a loaded or cocked position.

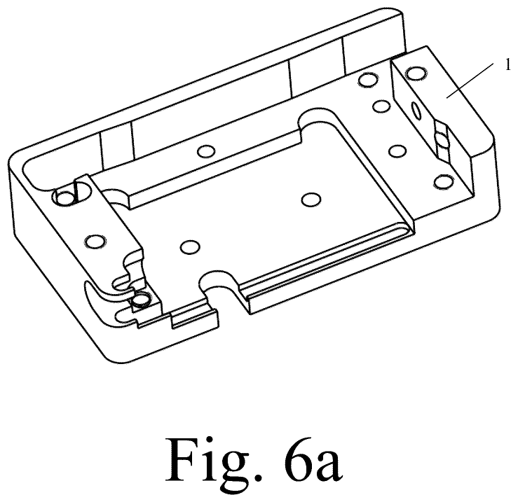

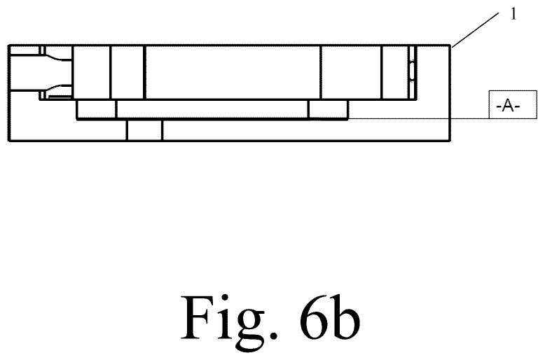

FIG. 6a is a perspective view of the main housing 1 of the present invention showing the main body cavity and the plurality of recesses needed for the manufacturing and retention of components in functional order and relationship of one embodiment of the present invention. FIG. 6b is an external side planar engineering view of the main housing 1 of a preferred embodiment of the present invention.

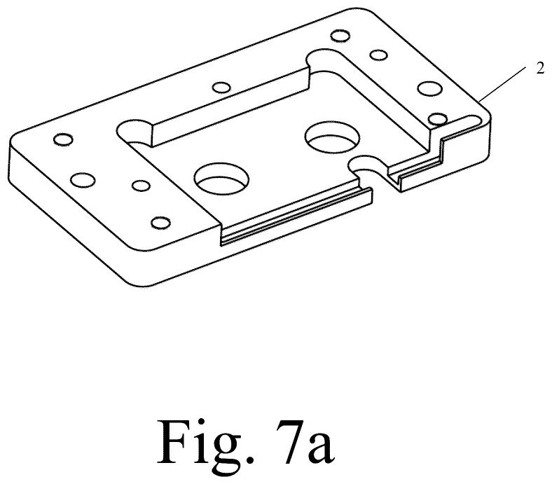

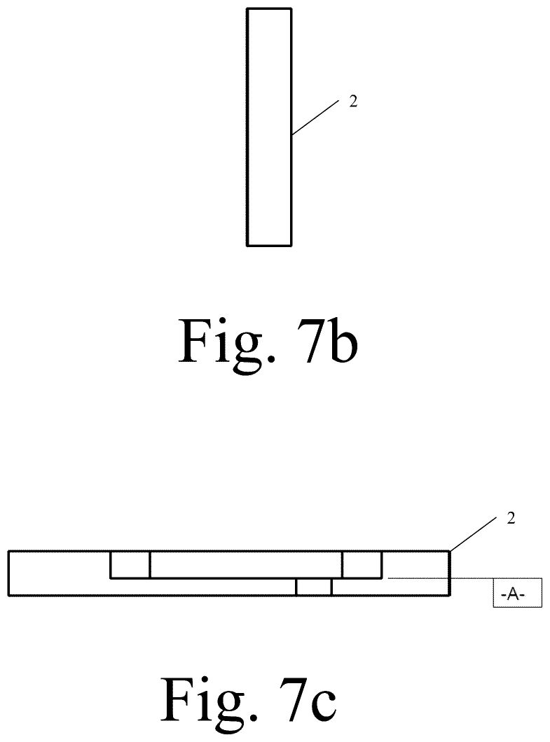

FIG. 7a is a perspective view of the main housing 1 mate of the present invention illustrating the main body cavity and the plurality of recesses needed for the manufacturing and retention of components in functional order and relationship of one embodiment of the present invention when the main housing mate 2 is secured to the main housing 1. It is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

FIG. 7b is an external side planar engineering view of the main housing 1 of a preferred embodiment of the present invention.

FIG. 7c is an external side planar view of the main housing 1 of the present invention of a preferred embodiment of the present invention.

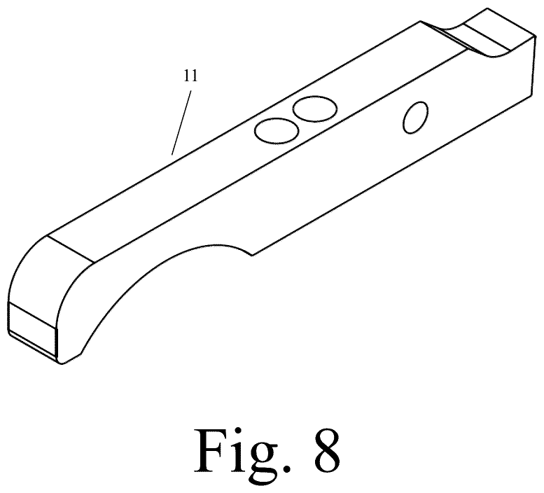

FIG. 8 is a perspective view of the trigger lever 11 of the present invention illustrating the internal cavities, shape, and recesses of a preferred trigger lever 11 embodiment of the present invention. It is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

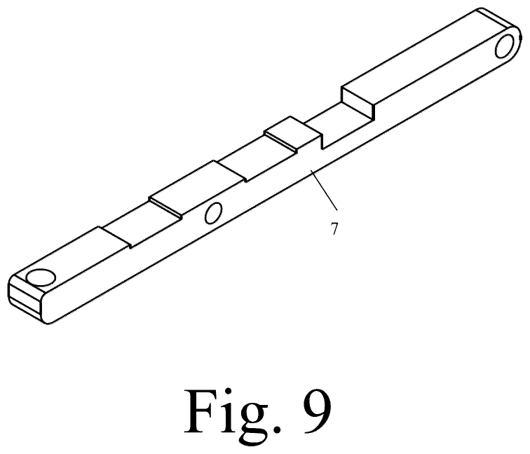

FIG. 9 is a perspective view of the sear lever 7 of the present invention illustrating the internal cavities, shape, and recesses of a preferred sear lever 7 embodiment of the present invention. It is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention

The method of operation of the transmission brake release trigger taught by the present invention starts when a racer pulls their vehicle up to the staging beams. When a racer would normally push the transbrake switch, the racer would push up on the external sear lever 7 end portion to set the transbrake switch and trigger. When a racer would normally release the transbrake switch, the racer pulls the external trigger. Pulling the external trigger releases the external sear lever 7 end to move down and the external sear lever 7 end pushes in on the plunger 9 on the micro switch 3. The micro switch 3 is electrically connected from the common to the normally closed (NC) position for this mode.

In an alternative embodiment, the switch can be installed with the pin the other way for normally open (NO) operation. The transmission brake switch device is slower actuating this way. In this embodiment, the pin plunger 9 that activates the internal switch is moved to the opposite side of the sear lever 7 pivot 8 as illustrated in FIG. 5a. Moving the pin plunger 9 to the side of the sear lever 7 pivot 8 closer to the internal sear lever 7 end aligns the pin plunger 9 with a second sear lever 7 recess located on the internal sear lever 7 side pivot 8 end and the pin plunger 9 is engaged or in compressed or closed position until the trigger lever 11 is pulled. Once the trigger lever 11 is pulled, the internal operation and movements occur as previously discussed and illustrated, except the pin plunger 9 is uncompressed and opened, allowing the switch and electrically controlled transbrake switch to operate in a normally open (NO) manner.

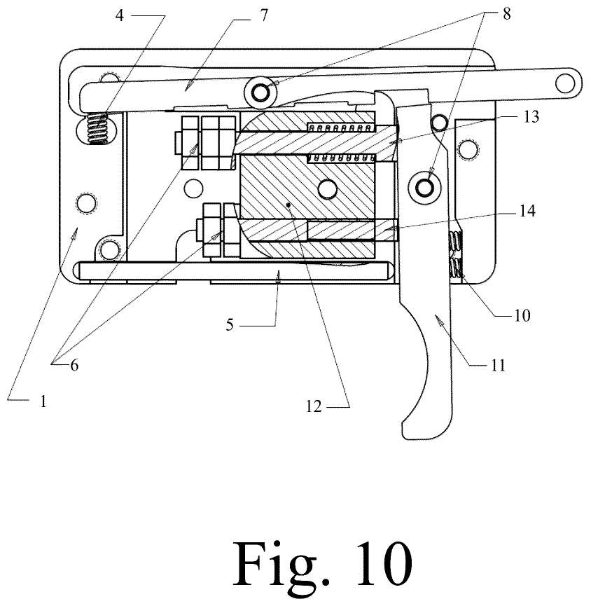

FIG. 10 illustrates a planar view of the assembled release trigger lever 11 taught by the present invention with the main housing mate 2 omitted showing all the internal components and their orientation and reference positions with respect to all other components for a direct contact embodiment using a switch block 12, which is faster for the instant on racers.

In this embodiment, the switch is comprised of a spring-loaded primary switch contact 13 and a stationary secondary switch contact 14 which are both in contact with or engage the trigger lever 11 depending on the position of the trigger lever 11. In this embodiment, the components are arranged in a similar orientation but the change in switch orientation and contacts results in a direct contact orientation with the trigger lever 11 and results in a faster acting and reacting trigger and switch, which is important to instant on or instant green racers.

In this orientation the sear spring 4 is still used to load or “cock” the trigger. When the external end of the sear lever 7 is raised, the sear lever 7 trigger recess is moved away from the internal trigger lever 11 end and the internal trigger lever 11 end is free to move in a rearward orientation toward the external sear lever 7 end. The spring-loaded primary switch contact 13 places a rearward spring pressure force on the internal trigger lever 11 end while the trigger springs 10 create a forward spring pressure force on the external spring pressure end around the trigger pivot 8.

In a loaded or “cocked” position the stationary secondary switch contact 14 is in contact with the trigger lever 11. When the trigger lever 11 is pulled, the contact between the trigger lever 11 and the stationary secondary switch contact 14 is broken, which results in a signal being sent to the external transmission brake through the electrical connections 6 of the switch 3.

When the trigger is pulled, the internal trigger lever 11 end moves in a forward direction toward the internal sear lever 7 end and the internal trigger level aligns with the sear lever 7 trigger recesses and the sear lever 7 drops down over the internal trigger end until the external sear lever 7 end is raised in an upward position allowing the internal trigger lever 11 end to be pushed back by the trigger springs 10 and spring loaded primary switch and returned to a loaded or “cocked” position.

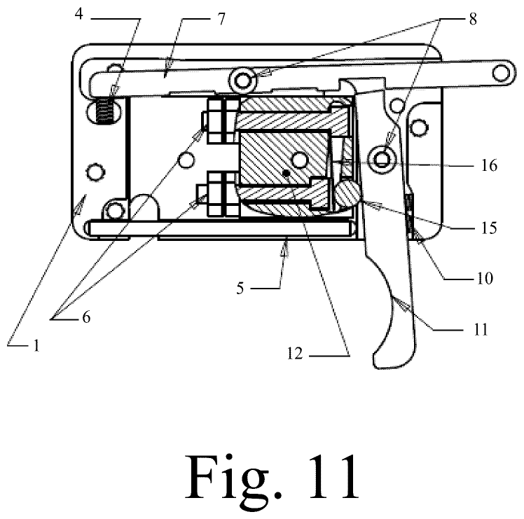

FIG. 11 illustrates a planar view of the assembled release trigger taught by the present invention with the main housing mate 2 omitted showing all the internal components and their orientation and reference positions with respect to all other components for a second direct contact embodiment using a switch block 12.

In this second, alternative embodiment, the electrical contact is from the top connection to the flat contractor strap held in place by the screw. When the sear lever 7 is set the trigger lever 11 moves forward, flexing the contactor trigger spring 10 through the transfer ball 15 onto the lower electrical connection 6. The transfer ball 15 is nonconductive, is loose in the bore and applies force to the flat spring contactor 16 to make the connection.

In this embodiment, the switch is comprised of a spring-loaded primary switch contact 13 and a stationary secondary switch contact 14 which are both in contact with or engage the trigger lever 11 depending on the position of the trigger lever 11. In this embodiment, the components are arranged in a similar orientation but the electrical contact is from the top connection to the flat contractor strap held in place by the screw. When the sear lever 7 is set the trigger lever 11 moves forward, flexing the contactor trigger spring 10 through the transfer ball 15 onto the lower electrical connection 6. The transfer ball 15 is nonconductive, is loose in the bore and applies force to the flat spring contactor 16 to make the connection.

In this orientation the sear spring 4 is still used to load or “cock” the trigger. When the external end of the sear lever 7 is raised, the sear lever 7 trigger recess is moved away from the internal trigger lever 11 end and the internal trigger lever 11 end is free to move in a rearward orientation toward the external sear lever 7 end. The spring-loaded primary switch contact 13 places a rearward spring pressure force on the internal trigger lever 11 end while the trigger springs 10 create a forward spring pressure force on the external spring pressure end around the trigger pivot 8.

In a loaded or “cocked” position the electrical contact is from the top connection to the flat contractor strap held in place by the screw. When the sear lever 7 is set the trigger lever 11 moves forward, flexing the contactor trigger spring 10 through the transfer ball 15 onto the lower electrical connection 6. The transfer ball 15 is nonconductive, is loose in the bore and applies force to the flat spring contactor 16 to make the connection.

When the trigger is pulled, the internal trigger lever 11 end moves in a forward direction toward the internal sear lever 7 end and the internal trigger level aligns with the sear lever 7 trigger recesses and the sear lever 7 drops down over the internal trigger end until the external sear lever 7 end is raised in an upward position allowing the internal trigger lever 11 end to be pushed back by the trigger springs 10 and spring loaded primary switch and returned to a loaded or “cocked” position.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A transmission brake release trigger, comprising:
a main housing for retaining an industrial micro switch with two electrical connections for connection to a standard electrically operated transmission brake;
a sear lever is mounted above the industrial micro switch;
the sear lever is mounted to the main housing using a single lever pivot;
a first sear lever end is retained within the main housing and engages a sear spring retained in a sear spring pocket or recess machined into the main housing;
an opposing end of the sear lever spring end extends from an opening in the main body housing providing an external means for re-setting, loading, or cocking the sear lever and connected trigger lever;
the trigger lever is mounted perpendicular to the sear lever engaging and being retained in position by a pivot point on the main housing;
one or more trigger lever springs are located in an internal recesses or pocket on the main housing;
the trigger lever springs create pressure on the trigger lever which must be overcome in order for the trigger lever to be moved; and
one end of the trigger lever engages a recess on the sear lever while an opposing end of the trigger lever extends from an opening in the main housing, creating an external trigger lever pull.

2. The device of claim 1, wherein
in operation, the external sear lever end or portion extending from the main housing is moved in a direction upward from the main housing;
this upward moving action creates an engagement the sear lever and the internal end of the trigger lever where the springs of trigger lever created a rear or backward pressure on the internal end of the trigger lever which places the end of the trigger lever is placed in a position just adjacent to the recess on the sear lever;
the sear lever springs create an upward pressure on the internal end of the sear lever, which creates a downward pressure on the sear lever end against the trigger leaver; and
in this position the trigger lever and sear lever are loaded or cocked and ready for release.

3. The device of claim 2, wherein
when the external trigger lever end extending from the main housing is pulled in a reward direction by a user, the trigger lever pivot creates a forward motion for the internal opposing end of the trigger lever;
when the internal end of the trigger leaver moves forward, the internal end of the trigger lever aligns with the recess on the sear lever and the sear lever is then able to move in a downward direction toward the trigger lever; and
when the sear lever recess moves over the end of the trigger lever, a pin plunger which activates the internal industrial micro switch is engaged by the sear lever and the switch is engaged, sending a signal to the electronic transmission brake.

4. The device of claim 3, wherein
to reset, reload, or cock the assembly,
the external sear level end is raised back upward until the trigger lever and its associated trigger lever springs move the trigger lever internal end reward and the external trigger lever end forward in the same fashion as a rifle or weapon trigger and the sear lever recess is disengaged from the internal trigger lever end; and
the sear lever rests against the internal trigger lever end and is held in place by the pressure created by the sear springs on the opposing end of the external sear spring via the sear lever pivot.

5. The device of claim 2, wherein
in operation, the sear lever has a sear spring located near the internal sear spring end which creates an upward force on the internal sear spring end, which transfers via the sear lever pivot to the external sear lever end as a downward force; and
it is this sear spring lever that creates the pressure to keep the sear lever engaged against the trigger lever and that causes the sear spring recess to move or engage over the trigger lever when the trigger lever is pulled.

6. The device of claim 2, wherein
the trigger lever springs create a forward pressure on the external trigger lever end which is transfers via the trigger lever pivot to the internal trigger lever end creating a reward pressure on the trigger lever which is used to keep the trigger lever engaged against the external sear lever end in a loaded or cocked position until the trigger lever spring pressure is overcome, typically by the squeezing pressure of a user.

7. The device of claim 2, wherein
due to the relationship between the sear lever and trigger lever and the forces applied by the sear lever springs and trigger lever springs,
the trigger lever can be retained in a loaded or cocked position until the trigger lever spring pressure is overcome allowing the internal end of trigger lever to move in a forward or inward direction bringing the trigger lever end in alignment with the sear lever recess;
allowing the sear lever to drop down as a result of the sear lever spring pressure and engage the trigger lever end, while the sear lever also engages a pin plunger on the industrial micro switch that activates the switch sending a signal to the electronic transmission brake.

8. The device of claim 7, wherein
the relationship between the sear lever and the trigger lever allows for the external sear lever end to be placed by into a loaded or cocked position by simply applying pressure and moving the external sear lever end in an upward direction until the sear lever springs are compressed; and
the recess of the sear lever is above the internal end of the trigger lever and the trigger lever springs move the internal trigger lever end in a backward direction disengaging the internal trigger lever end from the sear lever recess where the sear lever rests on top of the internal trigger lever end in a loaded or cocked position.

9. A release trigger lever assembly for an instant-on racing system, comprising:
an internal trigger lever;
a switch block configured for direct contact operation with a switching mechanism;
a spring-loaded primary switch contact positioned to apply rearward spring pressure on the internal trigger lever;
a stationary secondary switch contact configured to engage the internal trigger lever when in a cocked position;
a sear lever with a trigger recess, biased by a sear spring, and configured to release or reset the internal trigger lever based on its position; and
a trigger pivot and trigger springs arranged to apply forward spring pressure on the internal trigger lever, ensuring automatic return to the cocked position after actuation.

10. The release trigger lever assembly of claim 9, wherein pulling the internal trigger lever breaks contact with the stationary secondary switch contact, resulting in a signal being sent to an external transmission brake through electrical connections.

11. The release trigger lever assembly of claim 9, wherein the primary and secondary switch contacts are positioned for direct engagement with the internal trigger lever, enabling faster actuation and response for instant-on racing applications.

12. The release trigger lever assembly of claim 9, wherein the sear lever is configured to:
disengage the trigger recess from the internal trigger lever when the external end of the sear lever is raised, allowing the internal trigger lever to move rearward under the force of the primary switch contact; and
re-engage the internal trigger lever when the external end of the sear lever is lowered, resetting the assembly to the cocked position.

13. The release trigger lever assembly of claim 9, further comprising
an electrical switch coupled to the primary and secondary switch contacts, wherein the electrical switch is configured to control activation of an external transmission brake upon trigger actuation, ensuring minimal delay in signal transmission.

14. A release trigger lever assembly for an instant-on racing system, comprising:
an internal trigger lever;
a switch block comprising a spring-loaded primary switch contact and a stationary secondary switch contact, both configured to engage the internal trigger lever based on its position;
a sear lever with a trigger recess, biased by a sear spring, wherein the sear lever is configured to release or reset the internal trigger lever;
a contactor trigger spring positioned to flex and establish an electrical connection when the internal trigger lever moves forward; and
a nonconductive transfer ball positioned in a bore, wherein the transfer ball applies force to a flat spring contactor to establish electrical contact with a lower electrical connection when the trigger lever is actuated.

15. The release trigger lever assembly of claim 14, wherein the electrical contact is established between a top connection and a flat contactor strap held in place by a screw, and wherein the contactor trigger spring is flexed by the forward motion of the trigger lever through the transfer ball to complete the circuit.

16. The release trigger lever assembly of claim 14, wherein pulling the trigger lever causes the internal trigger lever to move forward, aligning with the trigger recess of the sear lever and allowing the sear lever to drop over the internal trigger lever to reset the assembly for subsequent operation.

17. The release trigger lever assembly of claim 14, wherein the spring-loaded primary switch contact applies rearward spring pressure on the internal trigger lever, and the trigger springs around a trigger pivot apply forward spring pressure, ensuring automatic return of the trigger lever to a cocked position after actuation.

18. The release trigger lever assembly of claim 14, wherein the transfer ball is loose within the bore to allow free movement and consistent force application on the flat spring contactor, ensuring reliable electrical contact during trigger actuation and enhanced response speed for instant-on racing applications.
